(19) United States
(12) Patent Application Publication
(10) Pub. No.: US 2026/0264685 A1
(43) Pub. Date: Sep. 10, 2026

(54) METHOD FOR CONTROLLING A DRIVE DEVICE FOR A WORKING MACHINE

(71) Applicant: ZF Friedrichshafen AG, Friedrichshafen (DE)

(72) Inventors: Nikolai EGLER, Riedhausen (DE); Joachim SAUTER, Berg (DE); Markus RIESTER, Wald (DE); Dieter BALZ, Wangen im Allgäu (DE); Raphael GONZALEZ, Leutkirch (DE)

(73) Assignee: ZF Friedrichshafen AG, Friedrichshafen (DE)

(21) Appl. No.: 19/557,903

(22) Filed: Mar. 5, 2026

(30) Foreign Application Priority Data
Mar. 5, 2025 (DE) 10 2025 108 351.7

(51) Int. Cl. B60W 30/18; B60W 10/14; B60W 10/16; B60W 10/196

(52) U.S. Cl. CPC B60W 30/18109; B60W 10/14; B60W 10/16; B60W 10/196; B60W 2300/125; B60W 2510/18; B60W 2710/125; B60W 2710/18

(57) ABSTRACT

A method is provided for controlling a drive device of a working machine having a motor (11), at least one lockable differential (21, 31, 32, 33), a brake mechanism (14), and a sensor setup. The sensor setup is designed to detect operating parameters, including a braking power of the brake mechanism (14). The method entails braking (I) the working machine by means of the brake mechanism (14), detecting (II) the braking power of the brake mechanism (14), locking (III) the at least one differential (21, 31, 32, 33) if a locking condition is met, which condition is at least met if the braking power reaches or exceeds a locking threshold value (x), and unlocking (IV) the at least one differential (21, 31, 32, 33) if an unlocking condition is met, which condition is at least met if the braking power reaches or falls below an unlocking threshold value (y).

### RELATED APPLICATIONS

This application claims the benefit of and right of priority under 35 U.S.C. § 119 to German Patent Application no. 10 2025 108 351.7, filed on 5 Mar. 2025, the contents of which are incorporated herein by reference in its entirety.

### TECHNICAL FIELD

The present invention relates to a method for controlling a drive device for a working machine, to a control unit for carrying out a method for controlling a drive device, to a drive device with a control unit, and to a working machine with a drive device.

### BACKGROUND

Methods for the control of a working machine are known. With the increasing complexity of working machines and the demands for high performance in working machines, there is a need for methods with which a working machine can be operated efficiently, reliably and economically.

### SUMMARY

It is a purpose of the present invention to provide a better method for controlling a drive device, which enables reliable operation of the working machine.

The objective is achieved by a method for controlling a drive device of a working machine as disclosed herein. Advantageous further will be apparent in light of the present disclosure.

In a first aspect, a method for controlling a drive device for a working machine is provided. The working machine can be in the form of a loader, tipper truck, or dump truck, for example an articulated dump truck. The drive device comprises a motor, at least one lockable differential, a brake mechanism and a sensor setup. The motor is designed to supply a drive power. The differential is designed to divide the drive power from an input element between two output elements. Conversely, the differential can be designed to transmit a braking force from the output elements to the input element. The brake mechanism is designed to brake the working machine, for example by way of the differential. The brake mechanism can comprise at least one of a friction brake and a retarder. The sensor setup is designed to detect a plurality of operating parameters, including the braking power of the brake mechanism.

The differential can be in the form of a longitudinal differential or a transverse differential. The working machine can comprise a longitudinal differential and at least one transverse differential. The working machine can comprise a working device. The working device can be designed to carry out a work task, such as lifting and/or transporting a load. The working device can be in the form of a loading surface, for example a tipper bridge. The motor can be in the form of an electric motor or an internal combustion engine, for example a diesel engine. The motor can have a drive input shaft. The drive input shaft can be mechanically functionally connected to an input element of the longitudinal differential in order to input a drive power.

At least one of the longitudinal differential and the transverse differentials can be in the form of a bevel-gear differential or a planetary differential. The longitudinal differential can be in the form of a planetary differential. The transverse differentials can be in the form of bevel-gear differentials. Each one of the longitudinal and the transverse differentials can have one input element and two output elements. One output element of the longitudinal differential can be mechanically functionally connected to an input element of one of the transverse differentials. The other output element of the longitudinal differential can be mechanically functionally connected to an input element of another one of the transverse differentials. In each case, one of the output elements of the longitudinal differential can be mechanically and functionally connected to the input element of one of the transverse differentials by way of either one of a cardan shaft or a transmission, for example a spur gear transmission. Each of the output elements of the transverse differentials can be mechanically and functionally connected, for example in a rotationally fixed manner or via a portal gear, to a traction element of the working machine. In that way, a braking force of the brake mechanism can be transmitted to at least one of the traction elements via at least one of the differentials.

When two elements are mechanically and functionally connected, they are directly or indirectly coupled to one another in such manner that a movement of one element brings about a reaction by the other element. For example, a mechanical functional connection can be formed by an interlocking or a frictional connection. The mechanical functional connection can correspond to the meshing of teeth of the two elements. Between the two elements further elements such as one or more spur gear stages can be provided. In contrast, a permanent rotationally fixed connection of two elements is understood to be a connection by means of which the two elements are connected solidly to one another under all normal circumstances of the transmission. In that case, the elements can be individual components connected rotationally fixed to one another, or they can be made integrally. By means of a shifting element, for example a clutch or brake, a rotationally fixed connection between two elements can be selectively formed or released.

In each case, one of the transverse differentials can be associated with a respective drivable axle unit, for example a drivable front axle or a drivable rear axle. In each case, one of the axle units can comprise one of the transverse differentials. In each case, one of the axle units can comprise two traction elements. The working machine can have, for example, three axle units. An axle unit can be in the form of a drivable front axle. An axle unit can be in the form of a first drivable rear axle. An axle unit can be in the form of a second drivable rear axle. An output element of the longitudinal differential can be mechanically functionally connected to the input element of the transverse differential of the first drivable rear axle. The first drivable rear axle can be designed as a through-drive axle. The through-drive axle can have a through-drive output element. The through-drive output element can be mechanically functionally connected to the input element of the transverse differential of the second rear axle, for example directly and without a longitudinal differential. The through-drive output element can be mechanically functionally connected via a further longitudinal differential to the input element of the transverse differential of the second rear axle.

The drive device can comprise a transmission. The transmission can be a continuously variable transmission. The transmission can provide at least one gear ratio for forward driving and a gear ratio for driving in reverse. The transmission can include the longitudinal differential. The transmission and the longitudinal differential can be accommodated together in a common housing, for example a transmission housing.

The longitudinal differential and the transverse differentials can be lockable, for example lockable by means of a shifting element. The drive device can comprise one shifting element for each differential. The shifting element can be in the form of a clutch, such as a disk clutch. The shifting element can be designed to be actuated or shifted by an actuator. The actuator can be a hydraulic or pneumatic actuator. By means of the actuator a locking pressure can be applied to the shifting element. By virtue of the locking pressure, for example by increasing the locking pressure, the shifting element can be designed to be closed. By closing the shifting element, the differential concerned can be lockable, for example completely, at least partially and/or continuously variably. The longitudinal and the transverse differentials can be designed to be continuously variably lockable, for example by applying a target pressure. Locking of at least one of the longitudinal and the transverse differentials can be initiated smoothly, for example by applying a pre-pressure and subsequently reducing it to a holding pressure.

Each of the transverse differentials can be designed, when in its open condition, to equalize the rotation speeds of the traction elements of the drive axle concerned. Each of the transverse differentials can be designed, when in its locked condition, to synchronously distribute the load or the drive power to the two traction elements of the axle unit concerned, for example, in order to reduce undesired slip between the traction elements or wheel-spin of one of the traction elements. This results in better traction of the working machine.

In its open condition, the longitudinal differential can be designed to distribute, for example to distribute in a load-dependent manner, the drive power to the transverse differentials. The longitudinal differential can be designed, in its locked condition, to synchronously distribute the load or the drive power, for example to the two mechanically functionally connected transverse differentials, for example those of the front axle and the first rear axle. This results in better traction of the working machine, for example in a case when all the traction elements of an axle unit are affected by undesired slip.

The sensor setup can comprise at least one sensor, for example at least one of a rotation speed sensor, a position sensor, a pressure sensor and a torque sensor. The sensor setup can comprise a rotation speed sensor for each output element of the transverse differentials, for example to detect the rotation speed of each of the output elements of the transverse differentials. The sensor setup can comprise at least four rotation speed sensors, for example two rotation speed sensors for the output elements of the transverse differential of the front axle and two rotation speed sensors for the output elements of the transverse differential of the rear axle. The sensor setup can comprise six rotation speed sensors, for example two additional rotation speed sensors for the output elements of the transverse differential of the second rear axle. The sensor setup can have a rotation speed sensor for each traction element, for example for detecting the rotation speeds of the traction elements, for example those of the drivable axle units. The sensor setup can have a rotation speed sensor for detecting the rotation speed of the respective output elements of the longitudinal differential.

The method entails a braking of the working machine by means of the brake mechanism and, for example, the differential. The method entails detecting the braking power of the brake mechanism. The method entails locking the at least one differential when a locking condition is met. The locking condition is met if at least the braking power reaches or exceeds a locking threshold value. The method entails unlocking the at least one differential when an unlocking condition is met. The differential can be locked and/or unlocked rapidly or smoothly. The unlocking condition is met when at least the braking power reaches or falls below an unlocking threshold value. The locking threshold value can be higher that the unlocking threshold value. The locking and unlocking threshold values can form a hysteresis. In that way an undesired unlocking or an undesired alternation between locking and unlocking of the differential can be avoided. The braking power can be detected for example by virtue of a degree of actuation, such as a brake pedal position. The braking power can be detected, for example from a retarder torque.

Braking of the working machine can bring about a weight distribution change. For example, a pressure force of traction elements on the ground surface by one of the axle units, for example the front axle, can increase and by one of the axle units, for example the rear axle, can decrease, Thereby, the traction elements on the axle unit with the reduced pressure force can become blocked. A braking effect on one of the axle units with an increased pressure force, for example the front axle, can be increased. The blocking of the traction elements on one of the axle units can be reduced or prevented by locking the differential, for example during vigorous braking maneuvers. By closing the differential, the braking force of one traction element on another traction element, for example with a high-pressure force and a good traction ratio, can be transmitted. By virtue of the present method a uniform force distribution, for example a uniform braking force distribution can be achieved.

In an embodiment of the method, the drive device can comprise at least one lockable longitudinal differential for dividing the drive power between at least two lockable transverse differentials. Each transverse differential can be designed to divide the drive power from one input element between two output elements. The locking of the at least one differential can include a locking first of the longitudinal differential and then, optionally, the locking of the transverse differentials.

At least one of the longitudinal differential and the transverse differential can be designed to be lockable manually or automatically. For manual locking, the locking condition can be met if an operating element such as a button in a vehicle cabin is actuated. A method for the automated unlocking of at least one of the longitudinal differential and the transverse differential can entail determining a rotation speed difference between the rotation speeds of the output elements of one of the respective transverse differentials. The method can entail locking of the longitudinal differential when a longitudinal differential locking condition is met. The longitudinal differential locking condition can be met when one of the rotation speed differences reaches or exceeds a locking threshold value, for example for a longitudinal differential waiting time. The method can entail determining the rotation speed difference for each of the transverse differentials. Thereby, the method can be designed to recognize the transverse differential or the axle unit where the undesired slip is taking place. The method can entail determining a rotation speed difference between a rotation speed of an output element of one of the transverse differentials and the rotation speed of an output element of another of the transverse differentials. In that way the method can be designed to recognize undesired slip of all the traction elements of an axle unit, or wheel-slip of a drivable axle.

The longitudinal differential locking condition can be met if at least one rotation speed difference of one of the transverse differentials exceeds the locking threshold value. The longitudinal differential locking condition can be met if the rotation speed difference of the output elements of different transverse differentials exceeds the locking threshold value. The locking threshold value can be higher than a rotation speed difference that occurs between the two output elements of a transverse differential when the working machine is driving round a curve, for example during the normal use of the working machine.

The method can entail locking of one of the transverse differentials if a transverse differential locking condition is met. The transverse differential locking condition can be met for the transverse differential whose rotation speed difference meets the longitudinal differential locking condition for a transverse differential waiting time or for the longitudinal differential waiting time and subsequently the transverse differential waiting time. In that way, the longitudinal differential can be locked before the transverse differential is locked. Conversely, the method can bring about the unlocking of the transverse differential before the unlocking of the longitudinal differential.

In an embodiment of the method, the locking condition for the longitudinal differential, for example the longitudinal differential locking condition, can be met if the braking power reaches or exceeds a first locking threshold value. The locking condition for the transverse differentials, for example the transverse differential locking condition, can be met if the braking power reaches or exceeds a second locking threshold value. The first threshold value can be lower than the second threshold value. In that way, the longitudinal differential can be locked before one of the transverse differentials is locked.

In an embodiment of the method, the unlocking condition for the longitudinal differential can be met if the braking power reaches or falls below a first unlocking threshold value. The unlocking threshold value for the transverse differentials can be met if the braking power reaches or falls below a second unlocking threshold value. The first unlocking threshold value can be lower than the second unlocking threshold value. In that way one or all of the transverse differentials can be unlocked before the longitudinal differential is unlocked.

In an embodiment of the method, the drive device can comprise a shifting element for locking the at least one differential. The shifting element can be designed to be actuated by a locking pressure. The sensor setup can be designed to detect the locking pressure. The locking can entail adapting the locking pressure to a pre-pressure, a subsequent reduction of the locking pressure to a holding pressure and a final adaptation of the locking pressure to a target pressure for locking the differential.

The locking pressure can be increased, for example, along a pressure gradient up to the pre-pressure. After the lapse of a holding time, the locking pressure can be reduced to a holding pressure, for example along a pressure gradient. After the lapse of a holding time, the locking pressure can be increased to a target pressure for locking the differential, for example along a pressure gradient. The pre-pressure, the holding pressure, and the target pressure can be made the same for different differentials. In that way, smooth locking can be achieved.

The unlocking of the differential can entail reducing the locking pressure to an unlocking holding pressure and a subsequent further reduction of the locking pressure in order to unlock the transverse differential. The locking pressure can be reduced to the unlocking holding pressure, for example along a pressure gradient. After the lapse of an unlocking holding time, the locking pressure can be reduced to unlock the differential. In that way, smooth unlocking can be achieved.

In an embodiment of the method, the brake mechanism can comprise at least one friction brake, which can be actuated by an actuation element such as a brake pedal. The sensor setup can be designed to detect the degree of actuation. The detection of the braking power can include detecting the degree of actuation, for example the brake pedal position. The locking threshold value and/or the unlocking threshold value can be related to a degree of actuation.

The actuation element can be located in a driver's cabin. The actuation element can be operated by a driver. The degree of actuation, for example the brake pedal position, can be determined by the position sensor. The braking power can be made proportional to the degree of actuation. A high braking power can be correlated with a forceful actuation of the actuation element, for example the brake pedal, and a high degree of actuation, for example a low brake pedal position. A low braking power can be correlated with a mild actuation of the actuation element, for example the brake pedal, and a low degree of actuation, for example a high brake pedal position. Depending on the degree of actuation, first the longitudinal differential and then one or all of the transverse differentials can be closed. With a high degree of actuation both the longitudinal differential and also the transverse differentials can be locked. With a low degree of actuation only the longitudinal differential can be locked. The friction brake can consist of an oil bath disk brake and/or a dry disk brake. The drive device can comprise a friction brake for each of the output elements and/or each of the traction elements. The friction brake can be located in the area of a wheel hub.

In an embodiment of the method, the brake mechanism can comprise a retarder. The sensor setup can be designed to detect a braking torque. The detection of the braking power can include a detection of the braking torque. The respective locking threshold value and/or unlocking threshold value can be correlated with a braking torque. The braking power can consist of the sum of the braking power of the friction brake and the braking power of the retarder. The method can provide other locking threshold values and/or unlocking threshold values for the braking power of the friction brake and for the braking power of the retarder.

The braking torque can consist of a retarder torque. The retarder torque can have negative values. The braking torque can consist of the value of the retarder torque. The retarder can be in the form of a primary retarder or a central retarder. The retarder can be in the form of an electro-dynamic or a hydrodynamic retarder. The retarder can be accommodated in the transmission housing. All the output elements and/or traction elements can be designed to be braked by a common retarder.

In a second aspect, a control unit is provided for carrying out a method according to any of the preceding embodiments. The features, effects and advantages applicable to the second aspect can stem from the first aspect. Furthermore, the features, effects, and advantages of the second aspect correspond to the features, effects, and advantages of the first aspect. The control unit can comprise an input interface and an output interface. The input interface can be designed to receive system information, for example at least one operating parameter such as a rotation speed of one of the output elements and/or traction elements, a braking power, a degree of braking such as a brake pedal position, a braking torque, a locking pressure, or the like. The output interface can be designed for controlling the differential, for example the longitudinal differential and/or the transverse differential.

In a third aspect, a drive device with a control unit according to the second aspect is provided. Further features, effects and advantages of the third aspect can stem from the previous aspects. Furthermore, the features, effects and advantages of the third aspect correspond to those of the preceding aspects. The drive device comprises a motor, at least one lockable differential, a brake mechanism, and a sensor setup. The motor is designed to produce a drive power. The differential is designed to divide the drive power from an input element between two output elements. The differential can be designed to transmit a braking force from one of its output elements to its input element and/or to another output element. The brake mechanism is designed to brake the working machine, for example by way of the differential. The sensor setup is designed to detect a number of operating parameters, including a braking power of the brake mechanism.

The drive device can comprise a plurality of drivable axle units. The drive device can comprise two drivable axle units, for example a drivable front axle and a drivable rear axle. The drive unit can comprise three axle units, for example an additional, drivable second rear axle. The drive device can comprise at least one longitudinal differential and two transverse differentials. The drive device can comprise one longitudinal differential and three transverse differentials. The drive device can comprise two longitudinal differentials and three transverse differentials. Each one of the two longitudinal and transverse differentials can comprise an input element and two output elements. The output elements of the transverse differentials can be designed to be mechanically functionally connected, for example by way of at least one of a portal gear and a universal joint shaft, to a traction element. The portal gear can comprise at least one of a spur gear stage and a planetary gearset. The portal gear can be located in the area of a wheel hub. The portal gear can be in the form of a wheel hub gear.

In a fourth aspect, a working machine with a drive device according to the third aspect is provided. Further features, effects and advantages of the fourth aspect can emerge from the preceding aspects. Furthermore, features, effects, and advantages of the fourth aspect correspond to those of the preceding aspects. The working machine comprises at least two traction elements, which for the propulsion of the working machine are each respectively mechanically and functionally connected to one of the output elements of the transverse differentials. In each case, one of the traction elements can be mechanically and functionally connected by at least one of a portal gear and a universal joint shaft to an output element of one of the transverse differentials. A traction element can be in the form of a drive wheel or a chain drive.

### BRIEF DESCRIPTION OF THE FIGURES

FIG. 1 is a view from above illustrating the principle of an embodiment of a working machine with a drive device.

FIG. 2 illustrates the principle of an embodiment of a method for controlling the drive device.

FIG. 3 is a diagram showing the temporal variation of operating parameters of an embodiment of the working machine while the method is being carried out.

FIG. 4 is a diagram showing the temporal variation of operating parameters of a further embodiment of the working machine while the method is being carried out.

FIG. 5 illustrates the principle of an embodiment of a control unit for carrying out the method.

### DETAILED DESCRIPTION OF EMBODIMENTS

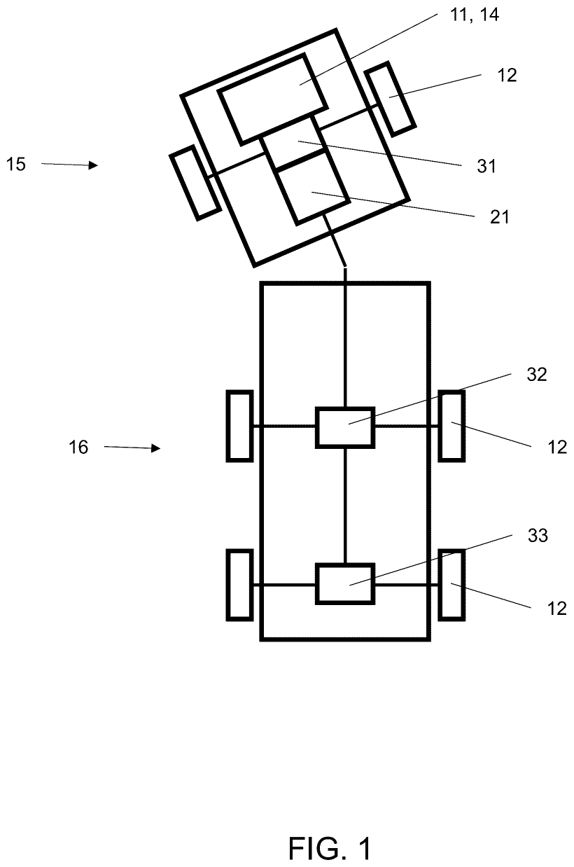

FIG. 1 is a view from above illustrating the principle of an embodiment of a working machine with a drive device. The working machine is an articulated dump truck. The working machine has a front section 15 and a rear section 16, which are connected to one another by an articulation joint for steering the working machine. The rear section 16 has two axle units, in this case a first drivable rear axle and a second drivable rear axle. The front section 15 has one axle unit, in this case a drivable front axle, and a motor 11. The front section 15 has a longitudinal differential 21 with an input element and two output elements. The front section 15 has a brake mechanism 14 with a retarder and a friction brake for each of the traction elements 12. A driveshaft of the motor 11 is mechanically and functionally connected to the input element of the longitudinal differential 21 in order to deliver a drive power. The longitudinal differential 21 is designed to divide the drive power between its two output elements. Conversely, the longitudinal differential 21 is designed to transmit a braking force from one of its output elements to its input element and/or to its other output element.

The drive device comprises three transverse differentials 31, 32, 33, each with an input element and two output elements. Each of the transverse differentials 31, 32, 33 is designed to divide a drive power from its input element between its two output elements. Conversely, each of the transverse differentials 31, 32, 33 is designed to transmit a braking force from one of its output elements to its input element and/or to its other output element. The drivable front axle comprises a first transverse differential 31. The first drivable rear axle comprises a second transverse differential 32. The second drivable rear axle comprises a third transverse differential 33. An output element of the first longitudinal differential 21 is mechanically functionally connected to the input element of the first transverse differential 31. The other output element of the first longitudinal differential 21 is mechanically functionally connected to the input element of the second transverse differential 32 by way of a universal joint shaft arrangement. The first rear axle is in the form of a through-drive axle and comprises a through-drive output element. The through-drive output element is mechanically functionally connected to the input element of the third transverse differential 33. Each of the output elements of the transverse differentials 31, 32, 33 is mechanically functionally connected to a respective traction element 12, in this case a drive wheel.

The drive device comprises a sensor setup. For each output element of the transverse differential s 31, 32, 33 the sensor setup has a rotation speed sensor for detecting the rotation speed of the output element concerned. The sensor setup comprises a position sensor for detecting a degree of actuation, for example a brake pedal position of a brake pedal. The sensor setup comprises a torque sensor for detecting a braking torque from the value of a retarder torque T. Each of the longitudinal differential 21 and the transverse differentials 31, 32, 33 is designed to be lockable by means of a shifting element. The shifting element is in the form of a disk brake and can be locked continuously variably by means of a hydraulic actuator.

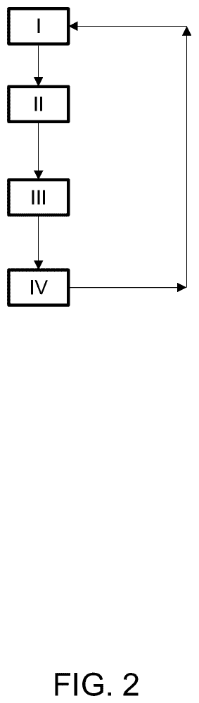

FIG. 2 illustrates the principle of an embodiment of a method for controlling the drive device. In a first step I, the method includes braking of the working machine by means of the brake mechanism 14. In a further step II, the method includes detecting the braking power of the brake mechanism 14. For the friction brakes, the detection step II includes detecting the degree of actuation. For the retarder, the detection step II includes detecting the braking torque.

In a further step III, the method entails locking the differentials 21, 31, 32, 33 if the braking power reaches or exceeds a locking threshold value x. In this case the locking threshold value x is related both to the degree of actuation Z and to a braking torque. In this case the longitudinal differential 21 is locked first, and then optionally the transverse differentials 31, 32, 33 are locked. The locking condition for the longitudinal differential 21 is met if the braking power reaches or exceeds a first locking threshold value x1. The locking condition for the transverse differentials 31, 32, 33 is met if the braking power reaches or exceeds a second locking threshold value x2. The first locking threshold value x1 is lower than the second locking threshold value x2.

In a further step IV, the method entails unlocking the differentials 21, 31, 32, 33 if the braking power reaches or falls below an unlocking threshold value y. The unlocking threshold value y in each case is related both to a degree of actuation Z and to a braking torque. The unlocking condition for the longitudinal differential 21 is met if the braking power reaches or falls below a first unlocking threshold value y1. The unlocking condition for the transverse differentials 31, 32, 33 is met if the braking power reaches or falls below a second unlocking threshold value y2. The first unlocking threshold value y1 is lower than the second unlocking threshold value y2.

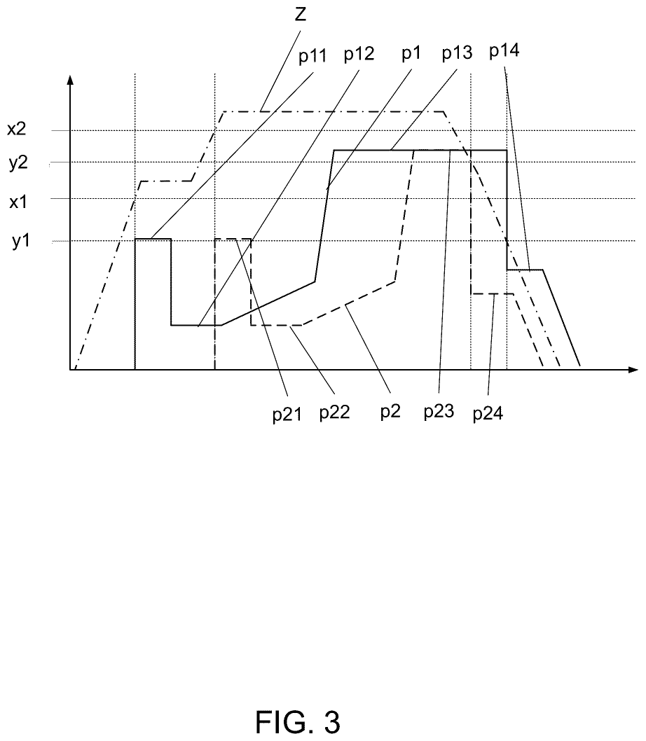

FIG. 3 is a diagram showing the temporal variations of operating parameters of an embodiment of the working machine while the method is being carried out. This diagram relates to a friction brake of one of the output elements of one of the transverse differentials 31, 32, 33. As soon as the degree of actuation Z exceeds the first locking threshold value x1, the longitudinal differential 21 is locked. For that, first a pre-pressure p11 is applied to the corresponding shifting element for a holding time. Then, the locking pressure pl for the longitudinal differential 21 is reduced to a holding pressure p12. After that, the locking pressure pl is increased smoothly along a two-step pressure gradient to a target pressure p13 in order to lock the longitudinal differential 21.

If the degree of actuation exceeds the second locking threshold value x2, the transverse differentials 31, 32, 33 are locked. For that, first a pre-pressure p21 is applied to the corresponding shifting element for a holding time. Then, the locking pressure p2 is reduced to a holding pressure p22. After that, the locking pressure p2 is increased smoothly along a two-step pressure gradient to a target pressure p23 in order to lock the transverse differentials 31, 32, 33.

If the degree of actuation falls below a second unlocking threshold value y2, the transverse differentials 31, 32, 33 are unlocked. For that, the locking pressure p2 for the transverse differentials 31, 32, 33 is first reduced to an unlocking holding pressure p24. After an unlocking holding time the locking pressure p2 is reduced smoothly along a gradient in order to unlock the transverse differentials 31, 32, 33.

If the degree of actuation Z falls below a first unlocking threshold value y1, the longitudinal differential 21 is unlocked. For that, the locking pressure pl for the longitudinal differential 21 is first reduced to an unlocking holding pressure p14. After an unlocking holding time the locking pressure pl is reduced smoothly along a gradient in order to unlock the longitudinal differential 21. The unlocking holding pressure p14 for the longitudinal differential 21 is higher than the unlocking holding pressure p24 for the transverse differentials 31, 32, 33.

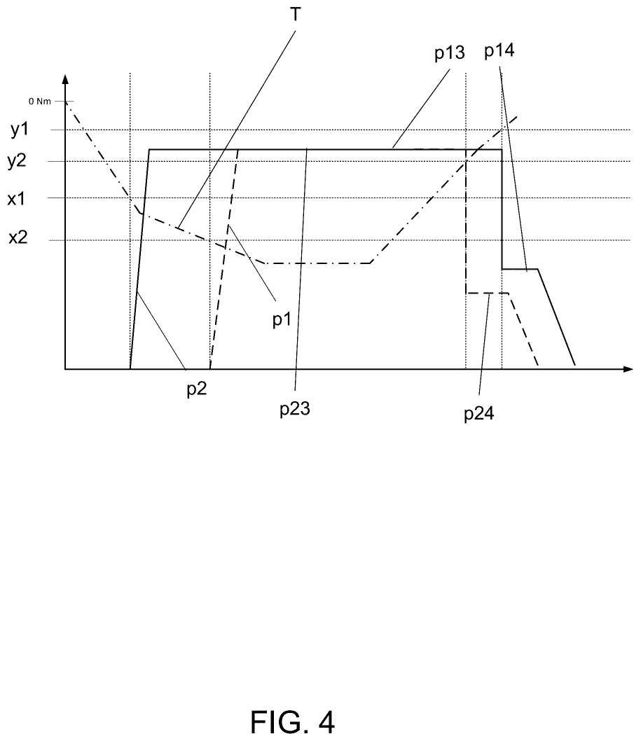

FIG. 4 is a diagram showing the temporal variation of operating parameters of a further embodiment of the working machine while the method is being carried out. This diagram relates to the retarder. As soon as the retarder torque T with a negative sign exceeds a first locking threshold value x1, the longitudinal differential 21 is locked. For that, the locking pressure pl for the longitudinal differential 21 is increased smoothly along a gradient to a target pressure p13 in order to lock the longitudinal differential 21.

If the retarder torque T with a negative sign exceeds a second threshold value x2, the transverse differentials 31, 32, 33 are locked. For that, the locking pressure p2 for the transverse differentials 31, 32, 33 is increased smoothly along a gradient to a target pressure p23 in order to lock the transverse differentials 31, 32, 33.

If the retarder torque T with a negative sign exceeds a second unlocking threshold value y2, the transverse differentials 31, 32, 33 are unlocked. For that, the locking pressure p2 for the transverse differentials 31, 32, 33 is first reduced to an unlocking holding pressure p24. After an unlocking holding time the locking pressure p2 is reduced smoothly along a gradient in order to unlock the transverse differentials 31, 32, 33.

If the retarder torque T with a negative sign falls below a first unlocking threshold value y1, the longitudinal differential 21 is unlocked. For that, the locking pressure p1 for the longitudinal differential 21 is first reduced to an unlocking holding pressure p14. After an unlocking holding time the locking pressure p1 is reduced smoothly along a gradient in order to unlock the longitudinal differential 21. The unlocking holding pressure p14 for the longitudinal differential 21 is higher than the unlocking holding pressure p24 for the transverse differentials 31, 32, 33.

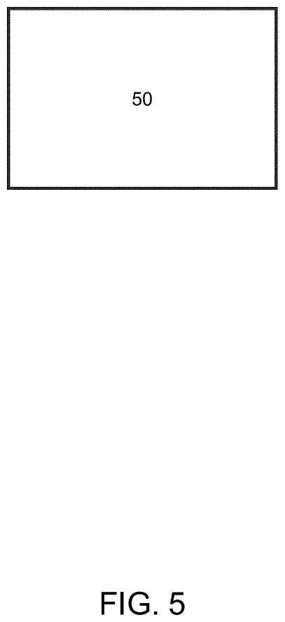

FIG. 5 illustrates the principle of an embodiment of a control unit 50 for carrying out the method. The control unit 50 comprises an input interface and an output interface. The input interface is designed to receive a rotation speed of the output elements, a degree of actuation Z, for example a brake pedal position, a retarder torque T and a locking pressure p1, p2. The output interface is designed to control the longitudinal differential 21 and the transverse differentials 31, 32, 33.

### INDEXES

11 Motor
12 Traction element
14 Brake mechanism
15 Front section
16 Rear section
21 Longitudinal differential
31 Transverse differential, first transverse differential
32 Transverse differential, second transverse differential
33 Transverse differential, third transverse differential
50 Control unit
T Retarder torque
Z Degree of actuation
X Locking threshold value
x1 First locking threshold value
x2 Second locking threshold value
y Unlocking threshold value
y1 First unlocking threshold value
y2 Second unlocking threshold value
p1, p2 Locking pressure
p11, p21 Pre-pressure
p12, p22 Holding pressure
p13, p23 Target pressure
p14, p24 Unlocking holding pressure
I Braking of the working machine
II Detection of the braking power
III Locking of the at least one differential
IV Unlocking of the at least one differential

1-10. (canceled)

11. A method for controlling a drive device for a working machine having a motor (11) for delivering a drive power, at least one lockable differential (21, 31, 32, 33) configured for dividing the drive power from an input element between two output elements, a brake mechanism (14) configured for braking the working machine, and a sensor setup configured for detecting a number of operating parameters, which include a braking power of the brake mechanism (14),
wherein the method comprises:
braking the working machine by means of the brake mechanism (14),
detecting the braking power of the brake mechanism (14);
determining that at least if the braking power reaches or exceeds a locking threshold value (x), thereby determining that a locking condition is met;
locking the at least one differential (21, 31, 32, 33) when a locking condition is met;
determining that the braking power reaches or falls below an unlocking threshold value (y), thereby determining that an unlocking condition is met; and
unlocking the at least one differential (21, 31, 32, 33).

12. The method according to claim 11, wherein:
the drive device comprises at least one lockable longitudinal differential (21) configured for dividing the drive power between at least two transverse differentials (31, 32, 33), wherein each transverse differential (31, 32, 33) is configured to divide the drive power from an input element between two output elements; and
locking the at least one differential (21, 31, 32, 33) comprises locking the longitudinal differential (21).

13. the method of claim 12 comprising locking the transverse differentials (31, 32, 33) after locking the longitudinal differential.

14. The method according to claim 12, wherein
determining that the locking condition is met for the longitudinal differential (21) includes determining that the braking power reaches or exceeds a first locking threshold value (x1); and
the locking condition is met for the transverse differentials (31, 32, 33) includes determining that the braking power reaches or exceeds a second locking threshold value (x2), and that the first locking threshold value (x1) is lower than the second locking threshold value (x2).

15. The method according to claim 12, wherein;
determining that the unlocking condition for the longitudinal differential (21) includes determining that the braking power reaches or falls below a first unlocking threshold value (y1); and
determining that the unlocking condition is met for the transverse differentials (31, 32, 33) includes determining that the braking power reaches or falls below a second unlocking threshold value (y2), and that the first unlocking threshold value (y1) is lower than the second unlocking threshold value (y2).

16. The method according to claim 11, wherein
the drive device comprises a shifting element configured for locking the at least one differential (21, 31, 32, 33);
the shifting element is configured to be actuated by a locking pressure (p1, p2);
the sensor setup is configured to detect the locking pressure (p1, p2), and
locking the at least one differential (21, 31, 32, 33) comprises adapting the locking pressure (p1, p2) to a pre-pressure (p11, p12), then reducing the locking pressure (p1, p2) to a holding pressure (p12, p22), and then adapting the locking pressure (p1, p2) to a target pressure (p13, p23) in order to lock the differential (21, 31, 32, 33).

17. The method according to claim 11, wherein:
the brake mechanism (14) comprises at least one friction brake configured to be actuated by an actuation element;
the sensor setup is configured to detect a degree of actuation (Z);
detecting the braking power of the brake mechanism (14) comprises detecting the degree of actuation (Z), and
the respective locking threshold value (x) and/or unlocking threshold value (y) is related to a degree of actuation (Z).

18. The method according to claim 11, wherein:
the brake mechanism (14) comprises a retarder;
the sensor setup is configured to detect a braking torque;
detecting the braking power of the brake mechanism (14) comprises detecting the braking torque; and
the respective locking threshold value (x) and/or unlocking threshold value (y) is related to a braking torque.

19. A control unit (50) comprising machine readable code that, when executed, carries out the method according to claim 11.

20. A drive device for a working machine, comprising:
a motor (11) configured for delivering a drive power;
at least one lockable differential (21, 31, 32, 33) configured for dividing the drive power from an input element between two output elements;
a brake mechanism (14) configured for braking the working machine;
a sensor setup configured for detecting a number of operating parameters, which include a braking power of the brake mechanism (14); and
a control unit configured to perform the following functions:
braking the working machine by means of the brake mechanism (14);
detecting the braking power of the brake mechanism (14);
determining that at least if the braking power reaches or exceeds a locking threshold value (x), thereby determining that a locking condition is met;
locking the at least one differential (21, 31, 32, 33) when a locking condition is met;
determining that the braking power reaches or falls below an unlocking threshold value (y), thereby determining that an unlocking condition is met; and
unlocking the at least one differential (21, 31, 32, 33).

21. A working machine comprising:
the drive device according to claim 21; and
at least two traction elements (12), which for the propulsion of the working machine are each mechanically and functionally connected to one of the output elements of the differential (21, 31, 32, 33).
